(19) United States
(12) Patent Application Publication
(10) Pub. No.: US 2022/0383300 A1
(43) Pub. Date: Dec. 1, 2022

(54) PAYMENT TRANSACTION PROCESSING SYSTEM, AND PAYMENT TRANSACTION PROCESSING METHOD AND APPARATUS

(71) Applicant: NETSUNION CLEARING CORPORATION, Beijing (CN)

(72) Inventor: Lingbin Kong, Beijing (CN)

(21) Appl. No.: 17/775,507

(22) PCT Filed: Nov. 10, 2020
(86) PCT No.: PCT/CN2020/127881

§ 371 Date: May 9, 2022

(30) Foreign Application Priority Data
Nov. 11, 2019 (CN) 201911096871.7

(51) Int. Cl. G06Q 20/38; G06Q 20/08

(52) U.S. Cl. CPC G06Q 20/382; G06Q 20/0855

(57) ABSTRACT

A payment transaction processing system and a payment transaction processing method and apparatus are disclosed. The system includes: an acquiring institution configured for initiating a payment transaction request; a clearing institution configured for receiving the payment transaction request, and sending the payment transaction request to the account institution; an account institution configured for processing the payment transaction request, generating a transaction result according to a processing result, and feeding back the transaction result to the clearing institution; if the transaction result is a payment processing result indicating that a third-party account opening institution performs payment, a clearing institution sends the payment transaction request to the third-party account opening institution, and receiving a first payment transaction result returned by the third-party account opening institution, and feeding back the first payment transaction result to the acquiring institution; and the third-party account opening institution is configured for, according to the payment transaction request, performing deduction, and after the deduction has been completed, generating the first payment transaction result, and feeding back the first payment transaction result to the clearing institution. The present application can improve the safety of the transaction payment, ensure the authenticity of the transaction information, and reduce the capital clearing risk.

### CROSS REFERENCE TO RELATED APPLICATIONS

The present application claims the priority of Chinese patent application No. 201911096871.7 filed on Nov. 11, 2019 by NetsUnion Clearing Corporation and entitled “PAYMENT TRANSACTION PROCESSING SYSTEM, AND PAYMENT TRANSACTION PROCESSING METHOD AND APPARATUS”.

### TECHNICAL FIELD

The present application relates to the field of payment, and particularly relates to a payment transaction processing system, and a payment transaction processing method and apparatus.

### BACKGROUND

With the development of e-commerce, electronic payment has been applied to various fields, and many payment platforms have emerged.

In the process of payment transactions, the account institutions, when deducting the capital of user, usually deduct the capital in the following two ways: first, directly deducting the account capital of the user in this institution; second, deducting the capital of the account opened by the user in another account opening institution via various payment transactions of a clearing institution. When the payment transactions are done by deducting the capital of the account opened by the user in another account opening institution, how to ensure the authenticity of the transaction information and reduce the clearing risk has become a critical problem to be solved.

### SUMMARY

The present application provides a payment transaction processing system, and a payment transaction processing method and apparatus, to improve the safety of the transaction payment, ensure the authenticity of the transaction information, and reduce the capital clearing risk.

An embodiment in the first aspect of the present application provides a payment transaction processing system. The payment transaction processing system comprises an acquiring institution, a clearing institution, an account institution and a third-party account opening institution;

the acquiring institution is connected to the clearing institution, and is configured for initiating a payment transaction request, and according to a first payment transaction result fed back by the clearing institution, performing merchant acquiring capital settlement;

the clearing institution is connected to the account institution, and is configured for receiving the payment transaction request initiated by the acquiring institution, and sending the payment transaction request to the account institution;

the account institution is configured for processing the payment transaction request, generating a transaction result according to a processing result, and feeding back the transaction result to the clearing institution;

the clearing institution is further configured for, when the transaction result is a payment processing result indicating that the third-party account opening institution performs payment, sending the payment transaction request to the third-party account opening institution, receiving the first payment transaction result returned by the third-party account opening institution, and feeding back the first payment transaction result to the acquiring institution; and

the third-party account opening institution is connected to the clearing institution, and is configured for, according to the payment transaction request, performing deduction, and after the deduction has been completed, generating the first payment transaction result, and feeding back the first payment transaction result to the clearing institution.

In the payment transaction processing system according to the embodiment of the present application, the clearing institution receives a payment transaction request initiated by an acquiring institution, and sends the payment transaction request to the account institution; the account institution processes the payment transaction request, generates a transaction result according to a processing result, and feeds back the transaction result to the clearing institution; when the transaction result is a payment processing result indicating that the third-party account opening institution performs payment, the clearing institution sends the payment transaction request to the third-party account opening institution, receives a first payment transaction result returned by the third-party account opening institution, and feeds back the first payment transaction result to the acquiring institution; and the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

An embodiment in the second aspect of the present application provides a payment transaction processing method. The method comprises:

receiving a payment transaction request initiated by an acquiring institution, and sending the payment transaction request to an account institution;

receiving a transaction result fed back by the account institution, wherein the transaction result is generated by the account institution according to a processing result of the payment transaction request;

if the transaction result is a payment processing result indicating that a third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and

feeding back the first payment transaction result to the acquiring institution, so that the acquiring institution performs merchant acquiring capital settlement according to the first payment transaction result.

The payment transaction processing method according to the embodiment of the present application comprises: receiving a payment transaction request initiated by an acquiring institution, and sending the payment transaction request to an account institution; receiving a transaction result fed back by the account institution, wherein the transaction result is generated by the account institution according to a processing result of the payment transaction request; when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and, subsequently, feeding back the first payment transaction result to the acquiring institution, so that the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

An embodiment in the third aspect of the present application provides a payment transaction processing apparatus. The apparatus comprises:

a first sending and receiving module configured for receiving a payment transaction request initiated by an acquiring institution, and sending the payment transaction request to an account institution;

a receiving module configured for receiving a transaction result fed back by the account institution, wherein the transaction result is generated by the account institution according to a processing result of the payment transaction request;

a second sending and receiving module configured for, when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and

a feeding-back module configured for feeding back the first payment transaction result to the acquiring institution, so that the acquiring institution performs merchant acquiring capital settlement according to the first payment transaction result.

The payment transaction processing apparatus according to the embodiment of the present application comprises receiving a payment transaction request initiated by an acquiring institution, and sending the payment transaction request to an account institution; receiving a transaction result fed back by the account institution, wherein the transaction result is generated by the account institution according to a processing result of the payment transaction request; when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and, subsequently, feeding back the first payment transaction result to the acquiring institution, so that the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

Some of the additional aspects and advantages of the present application will be given in the following description, and some will become apparent from the following description or be known from the implementation of the present application.

### BRIEF DESCRIPTION OF THE DRAWINGS

The above and/or additional aspects and advantages of the present application will become apparent and readily understandable from the following description on the embodiments with reference to the drawings. In the drawings:

FIG. 1 is an exemplary diagram of a process of deducting capital of an account opened by the user in another account opening institution in the prior art;

FIG. 2 is a schematic structural diagram of a payment transaction processing system according to an embodiment of the present application;

FIG. 3 is an exemplary diagram of a payment transaction process of the payment transaction processing system according to an embodiment of the present application;

FIG. 4 is a schematic flow chart of a payment transaction processing method according to an embodiment of the present application; and

FIG. 5 is a schematic structural diagram of a payment transaction processing apparatus according to an embodiment of the present application.

### DETAILED DESCRIPTION

The embodiments of the present application will be described in detail below, and the examples of the embodiments are illustrated in the drawings, wherein the same or similar reference numbers throughout the drawings indicate the same or similar elements or elements having the same or similar functions. The embodiments described below with reference to the drawings are exemplary, are intended to interpret the present application, and should not be construed as a limitation on the present application.

The payment transaction processing system, and the payment transaction processing method and apparatus according to the embodiments of the present application will be described below with reference to the drawings.

The participants of a payment transaction generally include a user (i.e., the payer), a merchant (i.e., the payee), an acquiring institution, an account institution and a clearing institution. The user purchases goods or service from the merchant, opens an account at the account institution, and performs transaction payment by using a means of payment. The merchant supplies the goods or service to the user, and, by using the acquiring service provided by the acquiring institution, accepts the transaction done by the user via various means of payment. The acquiring institution serves for the contract signing, the network accessing and the daily management of the merchant, receives and processes the payment instruction forwarded by the clearing institution, and performs the merchant capital settlement. The account institution serves for the account opening of the user, provides the account service, receives and processes the payment instruction forwarded by the clearing institution, and performs the user's capital settlement. The clearing institution serves for the receiving and processing of the payment instruction, and the clearing of the transaction capital, and serves for the transaction switching and the capital clearing in the payment transaction.

In the process of payment transactions, the account institution, when deducting the capital of the users, generally does so in the following two ways. One is directly deducting the account capital in this institution. For example, a commercial bank directly deducts the capital of a debit account or the limit of a credit account opened by the user in this institution; a non-bank payment institution directly deducts the limit of a payment account opened by the user in this institution. The other is deducting, via various payment transactions of the clearing institution, the capital of an account opened by the user in another account opening institution. For example, a commercial bank or non-bank payment institution deducts the capital of an account opened by the user in another commercial bank via the payment transactions of the clearing institution such as fast payment, gateway payment and collection.

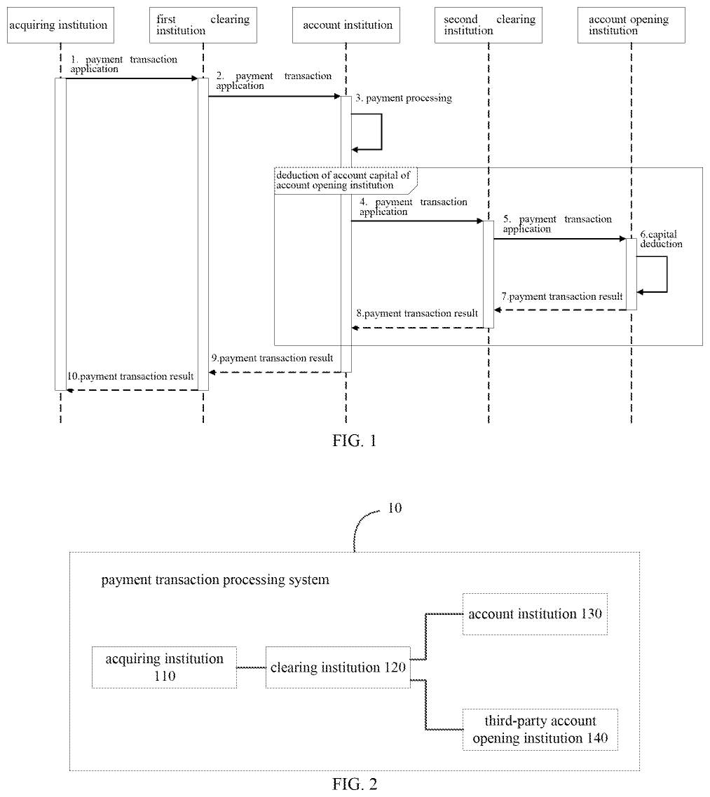

When, conventionally, the payment transaction is done by deducting the capital of the account opened by the user in another account opening institution, the payment transaction is usually divided into two payment processes: first, the acquiring institution initiates a payment instruction to the account institution via a first clearing institution; second, the account institution initiates a payment instruction to the account opening institution of the user via a second clearing institution. That will be described in detail below with reference to FIG. 1. FIG. 1 is an exemplary diagram of the process of deducting the capital of the account opened by the user in another account opening institution in the prior art. As shown in FIG. 1, the conventional process of payment transactions comprises:

(1) the acquiring institution invokes the payment transaction of the first clearing institution, including but not limited to fast payment, gateway payment, collection, barcode payment, human-face payment, online acquiring payment and near-field payment, and initiates a payment transaction application to the first clearing institution;

(2) the first clearing institution receives the payment transaction application of the acquiring institution, and forwards it to the account institution;

(3) the account institution receives the payment transaction application of the first clearing institution, and performs transaction processing;

(4) when the user selects to perform the payment by using an account opened in another account opening institution, the account institution invokes the payment transaction of the second clearing institution, including but not limited to fast payment, gateway payment and collection, initiates a payment transaction application to the second clearing institution;

(5) the second clearing institution receives the payment transaction application of the account institution, and forwards it to the account opening institution;

(6) the account opening institution receives the payment transaction application of the second clearing institution, and performs the deduction of capital of the user;

(7) the account opening institution returns the payment transaction result to the second clearing institution;

(8) the second clearing institution receives the payment transaction result of the account opening institution, and forwards it to the account institution;

(9) the account institution receives the payment transaction result of the second clearing institution, and returns the payment transaction result to the first clearing institution; and

(10) the first clearing institution receives the payment transaction result of the account institution, and forwards it to the acquiring institution.

It can be seen that, in the conventional process of payment transactions of deducting the capital of the account opened by the user in another account opening institution, one payment transaction is divided by the account institution into two independent payment processes. The account institution can withhold and hide the end-to-end payment transaction information, and the clearing institution cannot know the actual capital flow of the payment transaction. For example, the account institution hides from the acquiring institution and the first clearing institution the information of the account opened by the user and the actual capital source, and hides from the second clearing institution and the account opening institution the merchant information and the actual capital destination, which results in that the authenticity of the transaction information cannot be ensured. Furthermore, the account institution, when receiving a payment transaction application of a consumption-type payment service filed by the first clearing institution, might convert the consumption-type payment service into a transferring-type payment service or a recharging-type payment service, and subsequently initiates the payment transaction application to the second clearing institution, and the payment service attribute is changed, which results in that the authenticity of the transaction information cannot be ensured. In addition, in the process of capital clearing, the first clearing institution clears the capital from the account institution to the acquiring institution, and the second clearing institution clears the capital from the account opening institution to the account institution. If the account institution does not receive the clearing capital of the second clearing institution, the capital clearing of the first clearing institution will be affected, which results in a clearing risk.

In order to solve the above problems, the present application discloses a payment transaction processing system. The system can realize that, in the deduction of the capital of the account opened by the user in another account opening institution, the clearing institution merges the two independent payment processes (i.e., the acquiring institution initiates the payment instruction to the account institution, and the account institution initiates the payment instruction to the account opening institution), and after the acquiring institution has initiated the payment transaction request to the account institution via the clearing institution, the clearing institution, according to the transaction result returned by the account institution, directly initiates the payment transaction request to the account opening institution, which can prevent the account institution from withholding the payment transaction information, and enable the clearing institution to know the actual end-to-end capital flow of the payment transaction, thereby maintaining the payment service attribute, ensuring the authenticity of the transaction information, and eliminating the capital clearing risk.

FIG. 2 is a schematic structural diagram of the payment transaction processing system according to an embodiment of the present application.

As shown in FIG. 2, the payment transaction processing system 10 comprises an acquiring institution 110, a clearing institution 120, an account institution 130 and a third-party account opening institution 140.

The acquiring institution 110 is connected to the clearing institution 120, and is configured for initiating a payment transaction request, and according to a first payment transaction result fed back by the clearing institution 120, performing merchant acquiring capital settlement.

The acquiring institution 110 is connected to the account institution 130, and is configured for receiving the payment transaction request initiated by the acquiring institution 110, and sending the payment transaction request to the account institution 130.

The account institution 130 is configured for processing the payment transaction request, generating a transaction result according to a processing result, and feeding back the transaction result to the clearing institution 120.

The clearing institution 120 is further configured for, when the transaction result is a payment processing result indicating that the third-party account opening institution performs payment, sending the payment transaction request to the third-party account opening institution 140, receiving the first payment transaction result returned by the third-party account opening institution 140, and feeding back the first payment transaction result to the acquiring institution 110.

The third-party account opening institution 140 is connected to the clearing institution 120, and is configured for, according to the payment transaction request, performing deduction, and after the deduction has been completed, generating the first payment transaction result, and feeding back the first payment transaction result to the clearing institution 120.

In the present embodiment, when the user and the merchant are performing a payment transaction, the merchant charges the user via the acquiring institution 110. The acquiring institution 110 invokes the payment service of the clearing institution 120, including but not limited to fast payment, gateway payment, collection, barcode payment, human-face payment, online acquiring payment and near-field payment, and initiates a payment transaction request to the clearing institution 120. The account institution 130 forwards the received payment transaction request to the account institution 130. The account institution 130 processes the payment transaction request, generates a transaction result according to the processing result, and feeds back the transaction result to the clearing institution 120. The clearing institution 120, after receiving the transaction result, if knowing that the transaction result is a payment processing result indicating that the third-party account opening institution performs the payment, sends a payment transaction request to the third-party account opening institution 140 indicated by the payment processing result. The third-party account opening institution 140 performs the deduction according to the payment transaction request, and after the deduction has been completed, generates the first payment transaction result, and feeds back the first payment transaction result to the clearing institution 120. The clearing institution 120, after receiving the first payment transaction result fed back by the third-party account opening institution 140, feeds back the first payment transaction result to the acquiring institution 110. The acquiring institution 110 performs the merchant acquiring capital settlement according to the first payment transaction result.

Optionally, in an optional implementation of the embodiment of the present application, the clearing institution 120 is further configured for sending the first payment transaction result to the account institution 130; and the account institution 130 is further configured for, according to the first payment transaction result, performing user's capital settlement.

In an optional implementation of the embodiment of the present application, the clearing institution 120 is further configured for, when the transaction result is a second payment transaction result indicating that the account institution 130 has completed the deduction, feeding back the second payment transaction result to the acquiring institution 110. The acquiring institution 110 is further configured for, according to the second payment transaction result, performing the merchant acquiring capital settlement.

In an embodiment of the present application, the payment processing result contains: a name and an identifier of the third-party account opening institution, and account information and/or account marking information of a user in the third-party account opening institution. In other words, the payment processing result may contain the name and identifier of the third-party account opening institution and the account information of the user in the third-party account opening institution, or contain the name and identifier of the third-party account opening institution and the account marking information of the user in the third-party account opening institution, or contain the name and identifier of the third-party account opening institution and the account information and the account marking information of the user in the third-party account opening institution.

The third-party account opening institution may, for example, be a bank. The account information may, for example, be the account name, the account serial number, the identity information, the contact information and so on of the user in bank. The account marking information may be a payment marker corresponding to the account information.

In an embodiment of the present application, the account institution 130 may select by itself to perform the deduction in this institution or perform the deduction from the third-party account opening institution, and may also receive the deduction approach selected by the user, process the payment transaction request according to the selection by the user, and generate the transaction result.

As an optional implementation, the account institution 130 is particularly configured for, when the capital balance of the account institution 130 is less than the amount to be deducted in the payment transaction request, determining a target third-party account opening institution from a third-party account opening institution list, acquiring the name and identifier of the target third-party account opening institution, and the account information and/or the account marking information of the user in the target third-party account opening institution, generating the payment processing result, and feeding back the payment processing result to the clearing institution 120.

As an example, the account institution 130 may be a payment platform, and the third-party account opening institution may be a bank. The user may bind at least one bank card in the payment platform by means of bank-card binding, and the account institution 130 generates the third-party account opening institution list according to the bank cards bound by the user. When the account institution 130 receives the payment transaction request, the account institution 130 may firstly perform the deduction from the account capital of the account institution 130 by default, and if the balance of the account capital is less than the amount to be deducted in the payment transaction request, then determine a target third-party account opening institution from the third-party account opening institution list, acquire the name and identifier of the target third-party account opening institution, and the account information and/or the account marking information of the user in the target third-party account opening institution, generate the payment processing result, and feed back the payment processing result to the clearing institution 120. The account institution 130, when determining the target third-party account opening institution, may select randomly a third-party account opening institution from the third-party account opening institution list as the target third-party account opening institution; alternatively, it may determine the first third-party account opening institution in the third-party account opening institution list as the target third-party account opening institution; alternatively, it may acquire a historic record of the payment transactions of the account institution 130, and determine the third-party account opening institution that was most recently used as the target third-party account opening institution.

Accordingly, when the capital balance of the account institution is insufficient for the payment of the amount to be deducted, by selecting the target third-party account opening institution as the means of payment, it can be ensured that the payment transaction is performed smoothly, thereby preventing interruption of the payment transaction due to capital insufficiency.

Optionally, the account institution 130 is further configured for, if the third-party account opening institution list is blank, in other words, the user has not a bound third-party account opening institution in the account institution 130, prompting the user to input the name of the third-party account opening institution and the account information of the user in the third-party account opening institution; and according to the name of the third-party account opening institution and the account information of the user in the third-party account opening institution that are inputted by the user, generating the payment processing result, and feeding back the payment processing result to the clearing institution 120.

Accordingly, when the third-party account opening institution is blank, by prompting the user to input the relevant information of the third-party account opening institution, generating the payment processing result according to the relevant information of the third-party account opening institution, and feeding back the payment processing result to the clearing institution, it can be further ensured that the payment transaction is performed smoothly.

As another optional implementation, the account institution 130 is particularly configured for exhibiting the third-party account opening institution list pre-stored in the account institution to the user; acquiring the name of the target third-party account opening institution selected by the user from the third-party account opening institution list; according to the name of the target third-party account opening institution, inquiring a pre-established correspondence relation between the names of the third-party account opening institutions and the account information and/or account marking information, and determining the target account information and/or the target account marking information corresponding to the name of the target third-party account opening institution; and according to the name of the target third-party account opening institution and the target account information and/or the target account marking information, generating the payment processing result, and feeding back the payment processing result to the clearing institution 120. The correspondence relation between the names of the third-party account opening institutions and the account information and/or account marking information may be established in advance according to the names of the third-party account opening institutions bound by the user in the account institution 130 and the corresponding account information and/or account marking information, and stored in the account institution 130.

Accordingly, by acquiring the name of the target third-party account opening institution selected by the user from the third-party account opening institution list, determining the target account information and/or the target account marking information corresponding to the name of the target third-party account opening institution, generating the payment processing result, and feeding back the payment processing result to the clearing institution, the flexible selection of deduction ways is realized, thereby improving the user experience.

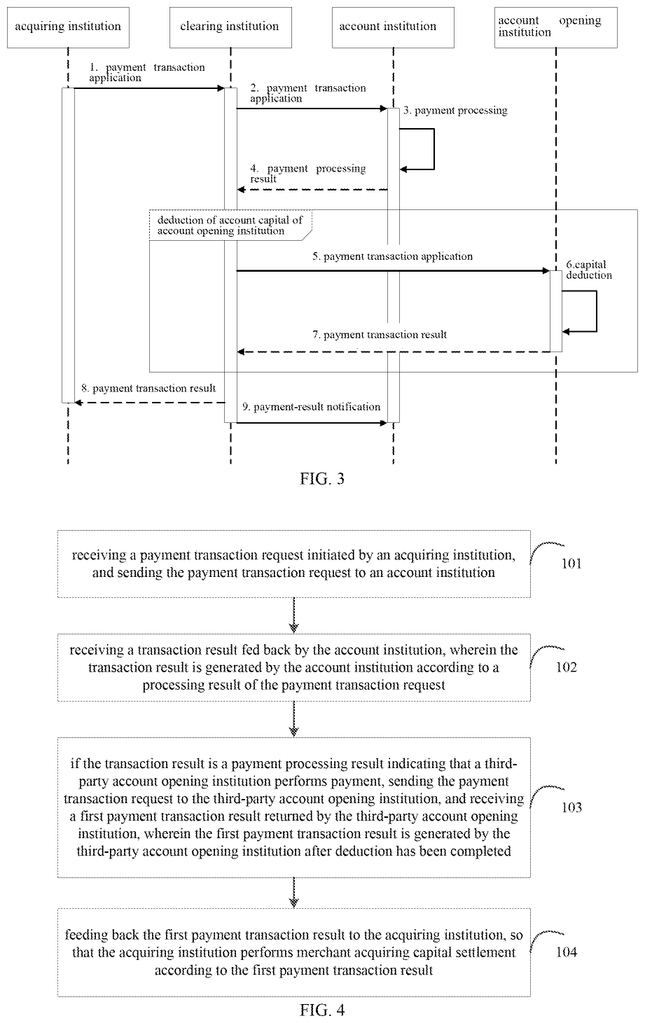

FIG. 3 is an exemplary diagram of the process of payment transaction of the payment transaction processing system according to an embodiment of the present application. As shown in FIG. 3, when the capital of the account opened by the user in another account opening institution is deducted by using the payment transaction processing system according to the embodiments of the present application, the transaction process is as follows:

(1) the acquiring institution invokes the payment service of the clearing institution, including but not limited to fast payment, gateway payment, collection, barcode payment, human-face payment, online acquiring payment and near-field payment, initiates a payment transaction application to the clearing institution;

(2) the clearing institution receives the payment transaction application of the acquiring institution, and forwards it to the account institution;

(3) the account institution receives the payment transaction application of the clearing institution, and performs transaction processing;

(4) when the payment is performed by using an account opened in the account opening institution, the account institution returns the payment processing result to the clearing institution, wherein the payment processing result contains the account opening institution (the name and identifier) and the account information and/or the account marking information of the user in the account opening institution;

(5) the clearing institution receives the payment processing result of the account institution, and initiates a payment transaction application to the account opening institution;

(6) the account opening institution receives the payment transaction application of the clearing institution, and performs the deduction of capital of the user;

(7) the account opening institution returns the payment transaction result to the clearing institution;

(8) the clearing institution receives the payment transaction result of the account opening institution, and forwards it to the acquiring institution; and

(9) the clearing institution notifies the payment transaction result to the account institution.

By comparing FIG. 1 and FIG. 3, it can be seen that, in the payment transaction processing system according to the present application, unlike the conventional solution, the clearing institution merges the two payment processes (i.e., the acquiring institution initiates a payment transaction application to the account institution, and the account institution initiates a payment transaction application to the account opening institution). When it is required to perform deduction from another account opening institution, the clearing institution directly initiates the payment transaction application to the account opening institution, which realizes that the transaction switching of one payment transaction is performed completely by one clearing institution. The account institution cannot withhold and hide the end-to-end payment transaction information, the clearing institution can know the actual capital flow of the payment transaction, and the account institution cannot change the payment service attribute, thereby improving the authenticity of the transaction information. Furthermore, in the process of capital clearing, the clearing institution directly clears the capital from the account opening institution to the acquiring institution, which eliminates the risk of capital clearing by multiple clearing institutions, and prevents illegal embezzlement of the clearing capital by the account institution, thereby improving the safety of the transaction payment.

In conclusion, in the payment transaction processing system according to the embodiment of the present application, the clearing institution receives a payment transaction request initiated by an acquiring institution, and sends the payment transaction request to the account institution; the account institution processes the payment transaction request, generates a transaction result according to a processing result, and feeds back the transaction result to the clearing institution; when the transaction result is a payment processing result indicating that the third-party account opening institution performs payment, the clearing institution sends the payment transaction request to the third-party account opening institution, receives a first payment transaction result returned by the third-party account opening institution, and feeds back the first payment transaction result to the acquiring institution; and the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

Corresponding to the above embodiments, the present application further provides a payment transaction processing method, and the method may be implemented by the clearing institution according to the above embodiments.

FIG. 4 is a schematic flow chart of the payment transaction processing method according to an embodiment of the present application. As shown in FIG. 4, the payment transaction processing method may comprise the following steps:

Step 101: receiving a payment transaction request initiated by an acquiring institution, and sending the payment transaction request to an account institution.

In the present embodiment, in the payment transaction, the acquiring institution invokes the payment service of the clearing institution, including but not limited to fast payment, gateway payment, collection, barcode payment, human-face payment, online acquiring payment and near-field payment, initiates a payment transaction application to the clearing institution. The clearing institution, after receiving the payment transaction request initiated by the acquiring institution, sends the payment transaction request to the account institution.

Step 102: receiving a transaction result fed back by the account institution, wherein the transaction result is generated by the account institution according to a processing result of the payment transaction request.

In the present embodiment, after the clearing institution has sent the payment transaction request to the account institution, the account institution processes the payment transaction request, and generates a transaction result according to the processing result.

Particularly, when the account institution completes the deduction in this institution, the account institution generates the second payment transaction result, and feeds back the second payment transaction result to the clearing institution. When it is required to perform the deduction from the third-party account opening institution, the account institution, according to the name and identifier of the third-party account opening institution and the account information and/or the account marking information of the user in the third-party account opening institution, generates the payment processing result, and feeds back the payment processing result to the clearing institution.

As an example, when the payment processing result is generated, if the capital balance of the account institution is less than the amount to be deducted in the payment transaction request, the account institution may determine a target third-party account opening institution from a third-party account opening institution list, acquire the name and identifier of the target third-party account opening institution, and the account information and/or the account marking information of the user in the target third-party account opening institution, generate the payment processing result, and feed back the payment processing result to the clearing institution. In addition, when the third-party account opening institution list is blank, the account institution may prompt the user to input the name of the third-party account opening institution and the account information of the user in the third-party account opening institution; and according to the name of the third-party account opening institution and the account information of the user in the third-party account opening institution that are inputted by the user, generate the payment processing result, and feed back the payment processing result to the clearing institution.

As another example, when the payment processing result is generated, the account institution may exhibit the third-party account opening institution list pre-stored in the account institution to the user; acquire the name of the target third-party account opening institution selected by the user from the third-party account opening institution list; according to the name of the target third-party account opening institution, inquire a pre-established correspondence relation between the names of the third-party account opening institutions and the account information and/or account marking information, and determine the target account information and/or the target account marking information corresponding to the name of the target third-party account opening institution; and according to the name of the target third-party account opening institution and the target account information and/or the target account marking information, further generate the payment processing result, and feed back the payment processing result to the clearing institution.

Step 103: if the transaction result is a payment processing result indicating that a third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed.

In the present embodiment, the clearing institution, after receiving the transaction result returned by the account institution, if knowing that the transaction result is a payment processing result indicating that the third-party account opening institution performs the payment, sends a payment transaction request to the third-party account opening institution indicated by the payment processing result. The third-party account opening institution, after receiving the payment transaction request, processes the payment transaction request, performs the deduction according to the payment transaction request, and after the deduction has been completed, generates the first payment transaction result, and feeds back the first payment transaction result to the clearing institution.

Moreover, in an embodiment of the present application, if the transaction result received by the clearing institution is the second payment transaction result indicating that the account institution has completed the deduction, the clearing institution feeds back the second payment transaction result to the acquiring institution, and the acquiring institution performs the merchant acquiring capital settlement according to the second payment transaction result.

Step 104: feeding back the first payment transaction result to the acquiring institution, so that the acquiring institution performs merchant acquiring capital settlement according to the first payment transaction result.

In the present embodiment, the clearing institution receives the first payment transaction result returned by the account opening institution, and feeds back the first payment transaction result to the acquiring institution, and the acquiring institution performs merchant acquiring capital settlement according to the first payment transaction result.

Optionally, in an optional implementation of the embodiment of the present application, the clearing institution, after receiving the first payment transaction result returned by the account opening institution, sends the first payment transaction result to the account institution, so that the account institution performs user's capital settlement according to the first payment transaction result.

The payment transaction processing method according to the embodiment of the present application comprises receiving a payment transaction request initiated by an acquiring institution, and sending the payment transaction request to an account institution; receiving a transaction result fed back by the account institution, wherein the transaction result is generated by the account institution according to a processing result of the payment transaction request; when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and, subsequently, feeding back the first payment transaction result to the acquiring institution, so that the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

In order to implement the above embodiments, the present application further provides a payment transaction processing apparatus.

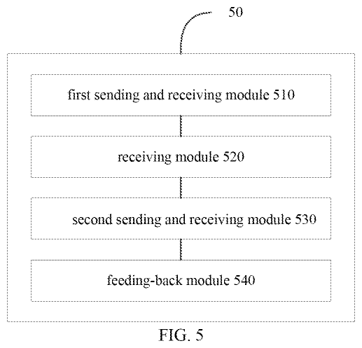

FIG. 5 is a schematic structural diagram of the payment transaction processing apparatus according to an embodiment of the present application. As shown in FIG. 5, the payment transaction processing apparatus 50 comprises a first sending and receiving module 510, a receiving module 520, a second sending and receiving module 530 and a feeding-back module 540.

The first sending and receiving module 510 is configured for receiving a payment transaction request initiated by an acquiring institution, and sending the payment transaction request to an account institution.

The receiving module 520 is configured for receiving a transaction result fed back by the account institution, wherein the transaction result is generated by the account institution according to a processing result of the payment transaction request.

The second sending and receiving module 530 is configured for, when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed.

The feeding-back module 540 is configured for feeding back the first payment transaction result to the acquiring institution, so that the acquiring institution performs merchant acquiring capital settlement according to the first payment transaction result.

Optionally, the feeding-back module 540 is further configured for sending the first payment transaction result to the account institution, so that the account institution performs user's capital settlement according to the first payment transaction result.

In an optional implementation of the embodiment of the present application, the feeding-back module 540 is further configured for, when the transaction result is a second payment transaction result indicating that the account institution has completed the deduction, feeding back the second payment transaction result to the acquiring institution, so that the acquiring institution performs merchant acquiring capital settlement according to the second payment transaction result.

It should be noted that the above explanation and description on the embodiments of the payment transaction processing method also apply to the payment transaction processing apparatus according to the present embodiment, and they share a similar principle of implementation, which is not discussed herein further.

The payment transaction processing apparatus according to the embodiment of the present application comprises receiving a payment transaction request initiated by an acquiring institution, and sending the payment transaction request to an account institution; receiving a transaction result fed back by the account institution, wherein the transaction result is generated by the account institution according to a processing result of the payment transaction request; when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and, subsequently, feeding back the first payment transaction result to the acquiring institution, so that the acquiring institution performs merchant acquiring capital settlement according to the first payment transaction result. Accordingly, when it is required to deduct capital from the third-party account opening institution, the payment transaction request is sent by the clearing institution to the third-party account opening institution to perform transaction switching, which prevents the account institution from withholding and hiding of the payment transaction information and changing the payment service attribute, thereby ensuring the authenticity of the transaction information. Furthermore, the clearing institution directly acquires the first payment transaction result of the third-party account opening institution, and feeds back the first payment transaction result to the acquiring institution, which realizes the clearing of capital by the clearing institution directly from the third-party account opening institution to the acquiring institution, eliminates the capital clearing risk caused by multiple clearing institutions, and prevents illegal embezzlement of the clearing capital by the account institution, thereby improving the safety of the transaction payment, and reducing the capital clearing risk.

In order to implement the above embodiments, the present application further provides a non-transitory computer-readable storage medium having a computer program stored thereon, wherein when the computer program is executed by a processor, the computer program implements the payment transaction processing method according to the above embodiments.

In the description of the present application, the description referring to the terms “an embodiment”, “some embodiments”, “example”, “particular example” or “some examples” and so on means that particular features, structures, materials or characteristics described with reference to the embodiment or example are comprised in at least one of the embodiments or examples of the present application. In the description, the illustrative expressions of the above terms do not necessarily relate to the same embodiment or example. Furthermore, the described particular features, structures, materials or characteristics may be combined in one or more embodiments or examples in a suitable form. Furthermore, when there is not a conflict, a person skilled in the art may combine different embodiments or examples described in the description and the features of the different embodiments or examples.

Moreover, the terms “first” and “second” are merely for the purpose of describing, and should not be construed as indicating or implying the degrees of importance or implicitly indicating the quantity of the specified technical features. Accordingly, the features defined by “first” or “second” may explicitly or implicitly comprise at least one of the features. In the description of the present application, the meaning of “plurality of” is “at least two”, for example, two, three and so on, unless explicitly and particularly defined otherwise.

Moreover, the function units according to the embodiments of the present application may be integrated in one processing module, the units may also physically exist separately, and two or more units may also be integrated in one module. The integrated module may be implemented in the form of hardware, and may also be implemented in the form of a software function module. The integrated module, if implemented in the form of a software function module and sold or used as an independent product, may be stored in a computer-readable storage medium.

The above-mentioned storage medium may be a read-only memory, a magnetic disk, an optical disk and so on. Although the embodiments of the present application have already been illustrated and described above, it can be understood that the above embodiments are illustrative, and should not be construed as a limitation on the present application, and a person skilled in the art may make variations, modifications, substitutions and improvements to the above embodiments within the scope of the present application.

1. A payment transaction processing system, comprising: an acquiring institution, a clearing institution, an account institution and a third-party account opening institution;
the acquiring institution is connected to the clearing institution, and is configured for initiating a payment transaction request, and according to a first payment transaction result fed back by the clearing institution, performing merchant acquiring capital settlement;
the clearing institution is connected to the account institution, and is configured for receiving the payment transaction request initiated by the acquiring institution, and sending the payment transaction request to the account institution;
the account institution is configured for processing the payment transaction request, generating a transaction result according to a processing result, and feeding back the transaction result to the clearing institution, wherein the account institution selects by itself to perform a payment in this institution or perform a payment from the third-party account opening institution, or receives a payment approach selected by a user, processes the payment transaction request according to the selection by the user, and generates the transaction result;
the clearing institution is further configured for, when the transaction result is a payment processing result indicating that the third-party account opening institution performs payment, sending the payment transaction request to the third-party account opening institution, receiving the first payment transaction result returned by the third-party account opening institution, and feeding back the first payment transaction result to the acquiring institution; and
the third-party account opening institution is connected to the clearing institution, and is configured for, according to the payment transaction request, performing deduction, and after the deduction has been completed, generating the first payment transaction result, and feeding back the first payment transaction result to the clearing institution.

2. The payment transaction processing system according to claim 1, wherein
the clearing institution is further configured for sending the first payment transaction result to the account institution; and
the account institution is further configured for, according to the first payment transaction result, performing user's capital settlement.

3. The payment transaction processing system according to claim 1, wherein
the clearing institution is further configured for, when the transaction result is a second payment transaction result indicating that the account institution has completed the deduction, feeding back the second payment transaction result to the acquiring institution; and
the acquiring institution is further configured for, according to the second payment transaction result, performing the merchant acquiring capital settlement.

4. The payment transaction processing system according to claim 1, wherein the payment processing result contains: a name and an identifier of the third-party account opening institution, and account information and/or account marking information of a user in the third-party account opening institution.

5. A payment transaction processing method, wherein the method is applied to a clearing institution, and the method comprises the steps of:
receiving a payment transaction request initiated by an acquiring institution, and sending the payment transaction request to an account institution;
receiving a transaction result fed back by the account institution, wherein the transaction result is generated by the account institution according to a processing result of the payment transaction request, wherein the account institution selects by itself to perform a payment in this institution or perform a payment from the third-party account opening institution, or receives a payment approach selected by a user, processes the payment transaction request according to the selection by the user, and generates the transaction result;
if the transaction result is a payment processing result indicating that a third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and
feeding back the first payment transaction result to the acquiring institution, so that the acquiring institution performs merchant acquiring capital settlement according to the first payment transaction result.

6. The payment transaction processing method according to claim 5, wherein after the step of receiving the first payment transaction result returned by the third-party account opening institution, the method further comprises:
sending the first payment transaction result to the account institution, so that the account institution performs user's capital settlement according to the first payment transaction result.

7. The payment transaction processing method according to claim 5, wherein after the step of receiving the transaction result fed back by the account institution, the method further comprises:
if the transaction result is a second payment transaction result indicating that the account institution has completed the deduction, feeding back the second payment transaction result to the acquiring institution, so that the acquiring institution performs merchant acquiring capital settlement according to the second payment transaction result.

8.-13. (canceled)

14. A payment transaction processing apparatus, wherein the apparatus is applied to a clearing institution, and the apparatus comprises:
a first sending and receiving module configured for receiving a payment transaction request initiated by an acquiring institution, and sending the payment transaction request to an account institution;
a receiving module configured for receiving a transaction result fed back by the account institution, wherein the transaction result is generated by the account institution according to a processing result of the payment transaction request, wherein the account institution selects by itself to perform a payment in this institution or perform a payment from the third-party account opening institution, or receives a payment approach selected by a user, processes the payment transaction request according to the selection by the user, and generates the transaction result;
a second sending and receiving module configured for, when the transaction result is a payment processing result indicating that the third-party account opening institution performs payment, sending the payment transaction request to the third-party account opening institution, and receiving a first payment transaction result returned by the third-party account opening institution, wherein the first payment transaction result is generated by the third-party account opening institution after deduction has been completed; and
a feeding-back module configured for feeding back the first payment transaction result to the acquiring institution, so that the acquiring institution performs merchant acquiring capital settlement according to the first payment transaction result.

15. The payment transaction processing apparatus according to claim 14, wherein the feeding-back module is further configured for:
sending the first payment transaction result to the account institution, so that the account institution performs user's capital settlement according to the first payment transaction result.

16. The payment transaction processing apparatus according to claim 14, wherein the feeding-back module is further configured for:
when the transaction result is a second payment transaction result indicating that the account institution has completed the deduction, feeding back the second payment transaction result to the acquiring institution, so that the acquiring institution performs merchant acquiring capital settlement according to the second payment transaction result.

17. (canceled)
